(19) United States
(12) Patent Application Publication
(10) Pub. No.: US 2001/0043215 A1
(43) Pub. Date: Nov. 22, 2001

(54) EFFICIENT DOWNLOADING OF ANIMATED PRESENTATION FILES

(76) Inventors: THOMAS M. MIDDLETON III, HINGHAM, MA (US); GREGORY T. WHITE, BEDFORD, MA (US)

Correspondence Address: DAVID J THIBODEAU JR, HAMILTON BROOK SMITH & REYNOLDS, TWO MILITIA DRIVE, LEXINGTON, MA, 024214799

(21) Appl. No.: 09/148,827

(22) Filed: Sep. 4, 1998

Related U.S. Application Data
(60) Provisional application No. 60/058,549, filed on Sep. 11, 1997.

(51) Int. Cl. G06T 13/00; G06T 15/70; G06F 15/16

(52) U.S. Cl. 345/473; 709/203

(57) ABSTRACT

A technique for permitting a Web page to include multimedia programs that are to be executed at the time that the page is displayed such as in an advertisement. The invention uses decompressors built into Web browsers and written in native code such as Graphical Image File (GIF) decompressors to encode not only images but also other information such as animation program code and sounds. As a result, special decompression software and/or animation plug-ins need not be downloaded to the Web browser prior to displaying an animated multimedia presentation as part of a Web page advertisement.

### RELATED APPLICATION

This application claims the benefit of U.S. Provisional Application Serial No. 60/058,549 filed on Sep. 11, 1997, the entire teachings of which are incorporated herein by reference.

### BACKGROUND OF THE INVENTION

Distributed computing environments are becoming an increasingly popular mechanism for publishing information. In such an environment, a network of several different types of computers is used to enable shared access to the information. Certain computers, known as the servers, contain databases or other repositories of information. Other computers in the network, known as clients, run so-called browser programs that act as the interface for human users to retrieve and display the information.

One particularly well known example of a distributed computing environment is the World Wide Web. In this environment, the Web server computers presently in use store data files or so-called Web pages, in a particular format known as Hypertext Markup Language (HTML). HTML permits the Web servers, or sites, to handle document files which contain or reference other files of varying formats. For example, a given Web page may include references to text content information files as well as to graphic image files or “GIFs.”

The current generation of browser programs, such as Netscape Navigator™ and Microsoft Internet Explorer™, allow a Web page file to include a program written in an interpretive language known as Java™. (Netscape Navigator™ is a trademark of Netscape Communications Corporation of Mountain View, Calif., and Microsoft Internet Explorer™ is a trademark of Microsoft Corporation of Redmond, Wash.) The Java™ language provides a programming environment within the context of a Web page in which developers may insert small programs to enable multimedia effects. Such multimedia effects may include not only still graphic images, but also the presentation of animated versions of graphic objects, as well as coordinated sounds.

In a common method of implementing multimedia effects, the byte code for a small helper or viewer program written in Java™ is downloaded together with the GIF file. The helper program contains Java™ byte codes with instructions for how to display the GIF and how to accomplish “media” effects, such as movement of an object across the screen, or playing a “movie” of a series of GIFs, and so forth. Indeed, the need to download and publish such multimedia files is increasingly necessary due to the widespread popularity of people “browsing” on the World Wide Web. Many sites contain advertisement portions on their Web pages exclusively devoted to enticing viewers to view other pages. These sites are in fact so popular that their operators provide their services free of charge to users of the Web and support themselves financially by selling advertising space on their Web pages. Thus, an advertiser may, for example a running shoe manufacturer, contract with an on-line service provider, such as America On Line (AOL™), or a search service, such as Yahoo™, so that their ads are periodically placed on their Web pages in much the same manner that television commercials are traditionally purchased from broadcasters. (AOL™ is a trademark of America On Line, Inc. of Dulles, Va., and Yahoo™ is a trademark of Yahoo! Corporation of Santa Clara, Calif.)

Perhaps because of the proliferation of such advertisements, it is becoming more desirable that they include aspects of multimedia in their presentations. As a result, certain technologies are presently available for expediting the delivery of multimedia information. For example, a copending U.S. patent Ser. No. 08/968,458, filed May 22, 1997 and entitled “Computer Method and Apparatus for Object Streaming,” by Scott A. Kliger, Thomas M. Middleton III, and Gregory T. White, which is assigned to Narrative Communications, Inc., the assignee of the present application, describes a technique for streaming data in a multimedia environment efficiently. In this technique, rather than treat each Web page as a complete file, a data stream is formed as a sequence of requested objects. The desired order of the sequence of objects is determined from a sequence of client requests for data, and the server may therefore track such client criteria to determine an optimum order for distribution of the objects.

However, there is still a need to speed up the process of downloading and displaying individual multimedia objects, even when the optimum order has been determined. This is perhaps due to the fact that Java™ is an environment with many constraints. First, Java™ is inherently a slow language, as it is not the native language of the target processor. Furthermore, there are extreme limitations on the number of data bytes that may be dedicated to representing the Java™ byte code for a newer program.

One approach to solving this has been to use “plug-in” programs that may be downloaded and added to the browser program to expedite the display of multimedia presentations in standardized formats. An example of one such plug-in is the Shockwave™ program. (Shockwave™ is a trademark of Macromedia, Inc. of San Francisco, Calif.) However, the practical uses of plug-in programs are limited to situations in which the user of the browser has downloaded the plug-in in advance of viewing the Web page. Thus, plug-ins are not particularly practical for implementing items such as a Web page advertisement, for which the user is not typically willing to spend many minutes or even hours reconfiguring a browser program.

What is needed is a way to expedite the delivery of animated GIFs, audio and sound files, and other such multimedia-related data and programs. This should be done in such a manner as to avoid the need for the user to download specific plug-in programs and the like, which are typically viewed as problematic in an environment such as presenting an advertisement on a Web page, and where the user will not or cannot wait for downloading of large byte code files.

### SUMMARY OF THE INVENTION

Briefly, the invention is a technique for encoding multimedia information and viewer programs intended to be presented in a Web page advertisement. At the server, a multimedia presentation is first assembled as a set of graphical images as well as viewer programs, sounds, and other information needed to represent the multimedia presentation. This composite file, together with a simple helper file, containing instructions for unpackaging the composite file, is encoded into a compressed format. The specific compression format is chosen to be compatible with the format of decompression software already known to be resident in native code in the typical browser. The compressed file is then sent to the browser over the network.

At the client side, the file is first presented to a decompressor. The decompressor generates a decompressed file. The helper program is then run to separate the images, viewer programs, and sounds from the composite file. The helper file then invokes the decompressed viewer programs with information on how to locate the local copies of the images and sounds as decompressed. The helper routines themselves then translate images and sounds according to the byte codes in the viewer program.

As a result, the downloading of animated multimedia presentations such as animated graphics may occur at a more rapid pace.

Furthermore, multimedia programs may contain far more complicated program logic and instructions since there typically are no restrictions on the size of the compressed image file.

### BRIEF DESCRIPTION OF THE DRAWINGS

The foregoing and other objects, features, and advantages of the invention will be apparent from the following more particular description of preferred embodiments of the invention, as illustrated in the accompanying drawings, in which like reference characters refer to the same parts throughout the different views.

FIG. 1 is a block diagram of a distributed computing system illustrating the manner of distributing a multimedia presentation file according to the invention.

FIG. 2 is a flow chart of the operations performed by a system operating according to the invention.

### DETAILED DESCRIPTION OF A PREFERRED EMBODIMENT

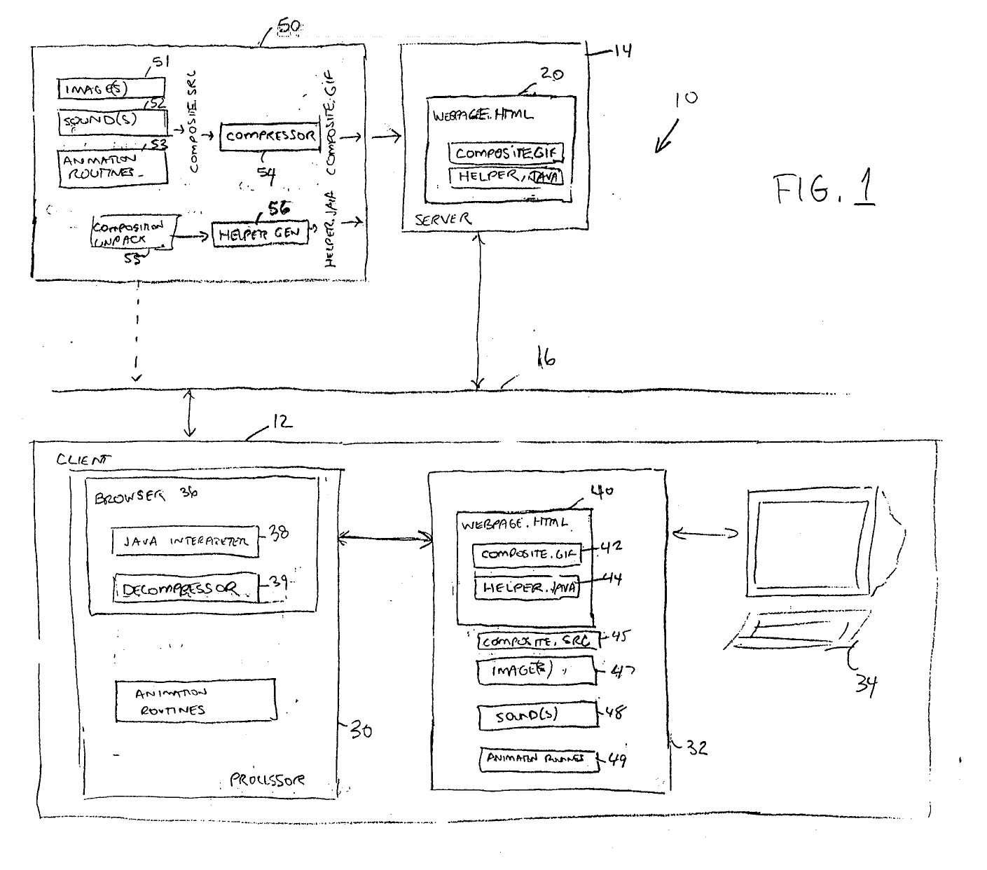

FIG. 1 is a block diagram of a distributed computing system 10 in which the use of a browser routine or helper file may be used to decompress animation images, sounds, and programs that are packaged in a composite image file in accordance with the invention. The distributed computing system 10 includes a number of computers 12, 14 interconnected by a communication medium 16. The communication medium 16, and in general the distributed computing system 10, may make use of any number of computer networking techniques, such as local area networks (LANs), routers, dial-up connections, and/or other data communication principles to form what has become known as an “intranet” or “internet.” In the preferred embodiment, the present invention is employed in what has become known as “the Internet,” which is an international computer network linking millions of many different types of computers together.

Typically, the computers 12 and 14 are personal computers, mini-computers, or the like. Certain of the computers in the distributed computing system 10 act as servers 12, and are used primarily to store and supply information. One type of server 12 which is in widespread use on the Internet is known as a Web server. Web servers 12 provide access to information stored in a format known as a Web page.

Other computers in the system 10 are known as clients 14 and are typically controlled by one user. The client computer 14 includes, as for any computer, a processor 30, storage 32, and a display 34. Storage 32 may include both memory and disk type storage. Client computers 14 allow a user to view Web pages 20 by downloading Web pages 20 from the server computer 12 over the communication medium 16. This function is specifically the responsibility of a browser program 36 resident on the processor 30. In this process, a local replica 40 of the original Web page 20 is created on the client computer 14.

The browser program 36 is preferably a browser software such as Netscape Navigator™ or Microsoft Explorer™. The browser program 36, in general, permits the user to create a view of the Web page 40 on the display 34. It should be understood that other programs may be resident and running on the processor 30 at the same time that the Web browser 36 is operating.

Browser programs 36 include and/or permit the use of embedded interpretive languages 38, such as Java™, that may execute programs that are included in the Web page file 40. Browser programs 36 also typically include decompression software 34 to enable the expedited communication of image data between the server 12 and client 14. In the particular example discussed herein, decompressor 39 is suitable for operating on image files encoded in the standard “Graphical Image File” (GIF) format.

It should be understood that the Web page 20 as stored on the server 12 includes a Uniform Resource Location (URL) pointing to a composite file, which is named “COMPOSITE.GIF” as well as a URL pointer to a Java™ applet or helper program “HELPER.JAVA.” To the server 12 the WEBPAGE.HTML file appears as any other HTML file containing a graphic image and a helper file containing instructions as to how to display the image.

However, the COMPOSITE.GIF and HELPER.JAVA files are actually created using a composition system 50 in accordance with the invention.

The composition system 50 is another computer, which may, or may not be the same computer as the server 14. The composition system 50 is responsible for accepting as input various representations of graphic images 51, sounds 52, and animation routines 53. The animation routines 53 are programs written in the Java™ interpretive language intended to be run by the browser 36 on the client 12, such as in Java™ byte code format. The images 51, sounds 52, and animation routines 53 are packaged into a single file by the composition system 50 to create a composite source file COMPOSITE.SRC. The COMPOSITE.SRC file arranges the images 51, sounds 52, and animation routines 53 into any convenient order or form. This order, whether specified by the human Web page designer or a predetermined default order, is in accordance with a known set of composition instructions 55. The composition instructions are used by a helper file generator 56 to produce a Java™ program called “HELPER.JAVA.” The HELPER.JAVA program simply contains instructions for how to unpackage and separate the images 51, sounds 52, and animation routines 53 from the COMPOSITE.SRC file.

The compressor 54 operates on the composite source file COMPOSITE.SRC to produce a compressed file COMPOSITE.GIF. The COMPOSITE.GIF file is created using standard loss-less compression algorithms for which the corresponding decompressor is built into standard Web browsers 36. For example, the compressor 54 preferably uses the Graphical Image Format (GIF) standard algorithms to compress the composite source file COMPOSITE.SRC.

At the server 12, URLs to the COMPOSITE.GIF and HELPER.APP files are inserted into the Web page 20.

When the user requests a view of the WEBPAGE.HTML file, a local replica 40 of the compressed composite file COMPOSITE.GIF is created on the client computer as well as a local replica 44 of the applet HELPER.JAVA. These replicas 42, 44 are typically stored in the storage 32 as part of the replica Web page file WEBPAGE.HTML.

As is the standard practice for displaying HTML files, the browser 36 eventually begins running the HELPER.JAVA file in order to display what it considers to be a standard image file COMPOSITE.GIF. During its execution, the HELPER.JAVA applet 44 presents the COMPOSITE.GIF file to the GIF decompressor 39 built into the browser 36 in the standard manner. This causes the GIF decompressor file 39 to generate a copy of the decompressed version, e.g., a local replica 45 of the COMPOSITE.SRC file.

The HELPER.JAVA applet 44 then runs the instructions in its composition unpackage routine to generate local replicas of the constituent components of the desired multimedia presentation. These components include local replicas of images 47, sounds 40, and animation routines 49 that correspond to the images 51, sounds 52, and animation routines 53 that were originally used in the composition system 50.

The HELPER.JAVA applet 44 then invokes the animation routines 49 on the processor 30 to animate the images 47, such as by presenting the images 47 in the desired order and at the desired times. The applet 44 may also use the sounds 48 to generate audible sounds at the desired times.

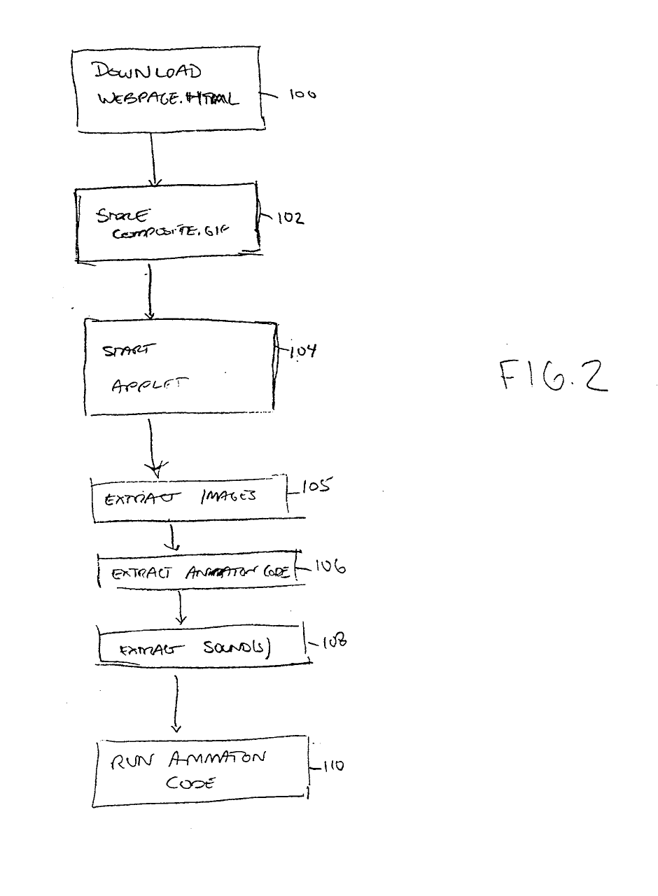

FIG. 2 is a flow chart of the steps performed by the processor 30, in a manner in accordance with the invention, to cause the display of a multimedia presentation. In a first step 100, the HTML file WEBPAGE.HTML is downloaded from the server 14 to create a local replica 40 on the client 12.

In a next step 102, the COMPOSITE.GIF file is extracted from the WEBPAGE.HTML file and sent to the GIF decompressor 39. As a result, a local copy 45 of the decompressed composite file COMPOSITE.SRC is created.

In step 104, the HELPER.JAVA applet 44 is then run by the browser 36 and a Java™ interpreter 36. In this process, the applet 44 operates on the decompressed COMPOSITE.SRC file 45 information to extract images 47, sounds 48, as well as additional animation code 49, as indicated in steps 106 and 108.

Finally, in step 110, all of the information needed to run the animated GIF is now available to the browser 36. The applet 44 may then, in step 110, cause the animation routines 49 to run and thereby create the intended effect on the display 34.

It can now be understood how the invention provides various advantages over the prior art. In particular, the invention includes a helper applet that is downloaded as part of a Web page 42, together with a composite compressed file. It is the composite compressed file that contains the majority of the routines needed to animate the presentation. As a result, multimedia presentations for the Internet may use animation programs that are much more complicated than standard Java™ applets. Therefore, the benefit of having a decompressor written in native code, which does not need to be downloaded in advance, can be taken full advantage of.

### EQUIVALENTS

While this invention has been particularly shown and described with reference to preferred embodiments thereof, it will be understood by those skilled in the art that various changes in form and details may be made therein without departing from the spirit and scope of the invention as defined by the appended claims. Those skilled in the art will be able to recognize or ascertain using no more than routine experimentation many equivalents to the specific embodiments of the invention described herein. Such equivalents are intended to be encompassed in the scope of the claims.

What is claimed is:

1. A process for displaying multimedia presentations as part of an advertisement portion of an electronic publication in a distributed computing environment containing server computers and client computers, the process comprising the steps of, at the client computer:
receiving an electronic publication file from the server computer containing a compressed composite file and a helper applet file, the compressed composite file containing image data and animation programs, and the helper applet file containing instructions for operating on the compressed composite file;
decompressing the compressed composite file to produce a composite source file; and
executing the helper applet file to separate out the image data and animation programs contained in the composite source file, and then to invoke the execution of the animation programs to present the image data.
